(19) United States
(12) Patent Application Publication
(10) Pub. No.: US 2017/0147587 A1
(43) Pub. Date: May 25, 2017

(54) Method for subtitle data fusion and electronic device

(71) Applicants: Le Holdings (Beijing) Co., Ltd., Beijing (CN); LE SHI INTERNET INFORMATION&TECHNOLOGY CORP., BEIJING, Beijing (CN)

(72) Inventor: Wei XUE, Beijing (CN)

(21) Appl. No.: 15/242,457

(22) Filed: Aug. 19, 2016

Related U.S. Application Data
(63) Continuation of application No. PCT/CN2016/083048, filed on May 23, 2016.

(30) Foreign Application Priority Data
Nov. 23, 2015 (CN) 2015108134719

(51) Int. Cl. G06F 17/30; H04N 21/8405

(52) U.S. Cl. CPC G06F 17/3082; H04N 21/8405; G06F 17/30867; G06F 17/30106

(57) ABSTRACT

What disclosed are a method for subtitle data fusion and electronic device. The method includes: grabbing multiple subtitle files and subtitle description information of the subtitle files with crawlers, and storing the multiple subtitle files and the subtitle description information of the subtitle files; selecting repetitive subtitle files from the multiple subtitle files, according to a similarity of the subtitle description information, and acquiring subtitle description information of the repetitive subtitle files; and fusing the subtitle description information of the repetitive subtitle files to obtain subtitle fusion description information.

### CROSS REFERENCE TO RELATED APPLICATIONS

This application is a continuation of International Application No. PCT/CN2016/083048, with an international filing date of May 23, 2016, which is based upon and claims priority to Chinese Patent Application No. 201510813471.9, filed on Nov. 23, 2015, the entire contents of all of which are incorporated herein by reference.

### TECHNICAL FIELD

The disclosure relates to the field of Internet technologies, and in particular to a method for subtitle data fusion and electronic device.

### BACKGROUND

As society progresses, people's spiritual demands are increasingly diversified. For example, more and more people like to watch American television dramas, Korean television dramas and other foreign movies and television dramas. However, no Chinese subtitle is provided for many foreign movie and television dramas, which brings big inconvenience for people being unfamiliar to foreign languages.

To solve this problem, a subtitle playing function is provided for many existing video players, but people still have to search for subtitle files on their own. Accordingly, a number of subtitle websites for providing subtitle files arise. People can get subtitle files through the subtitle websites. However, since some subtitle websites are maintained by enthusiasts other than professional subtitle personnel, description information in the subtitle files provided by the subtitle websites is not complete, even a large number of errors exist, thereby bringing much inconvenience in the searching process.

### SUMMARY

The disclosure provides a method for subtitle data fusion and electronic device, which are convenient for a user to get comprehensive and complete subtitle description information and improve the user experience.

According to one aspect of the disclosure, a method for subtitle data fusion is provided, which includes:

grabbing multiple subtitle files and subtitle description information of the subtitle files with crawlers, and storing the multiple subtitle files and the subtitle description information of the subtitle files;

selecting repetitive subtitle files from the multiple subtitle files, according to a similarity of the subtitle description information, and acquiring subtitle description information of the repetitive subtitle files; and

fusing the subtitle description information of the repetitive subtitle files to obtain subtitle fusion description information.

According to another aspect of the disclosure, an electronic device is provided, which includes:

at least one processor; and

a memory communicably connected with the at least one processor for storing instructions executable by the at least one processor, wherein execution of the instructions by the at least one processor causes the at least one processor to:

grab a plurality of subtitle files and subtitle description information of the subtitle files with crawlers, and store the plurality of subtitle files and the subtitle description information of the subtitle files;

select repetitive subtitle files from the plurality of subtitle files, according to a similarity of the subtitle description information, and acquire subtitle description information of the repetitive subtitle files; and

fuse the subtitle description information of the repetitive subtitle files to obtain subtitle fusion description information.

According to another aspect of the disclosure, here is provided a non-transitory computer-readable storage medium storing executable instructions that, when executed by an electronic device, cause the electronic device to:

grab a plurality of subtitle files and subtitle description information of the subtitle files with crawlers, and store the plurality of subtitle files and the subtitle description information of the subtitle files;

select repetitive subtitle files from the plurality of subtitle files, according to a similarity of the subtitle description information, and acquire subtitle description information of the repetitive subtitle files; and

fuse the subtitle description information of the repetitive subtitle files to obtain subtitle fusion description information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a schematic flowchart of a method for subtitle data fusion according to an embodiment of the disclosure;

FIG. 2 shows a schematic flowchart of a method for subtitle data fusion according to another embodiment of the present disclosure;

FIG. 3 is a schematic diagram of a management list;

FIG. 4 shows a schematic structural diagram of an apparatus for subtitle data fusion according to an embodiment of the present disclosure;

FIG. 5 shows a schematic structural diagram of an apparatus for subtitle data fusion according to an embodiment of the present disclosure;

FIG. 6 schematically shows a block diagram of a computing device for executing the method for subtitle data fusion according to the embodiments of the disclosure; and

FIG. 7 schematically shows a storage cell for holding or carrying procedure codes for realizing the method for subtitle data fusion according to the embodiments of the disclosure.

### DETAILED DESCRIPTION

The disclosure is described in further detail with reference to the drawings and embodiments below. Although the drawings show exemplary embodiments of the present disclosure, it should be understood that the present disclosure may be implemented in various forms but should not be limit to the embodiments set forth herein. On the contrary, these embodiments are contribute to a more thorough understanding of the present disclosure, and can completely convey the scope of the disclosure to those skilled in the art.

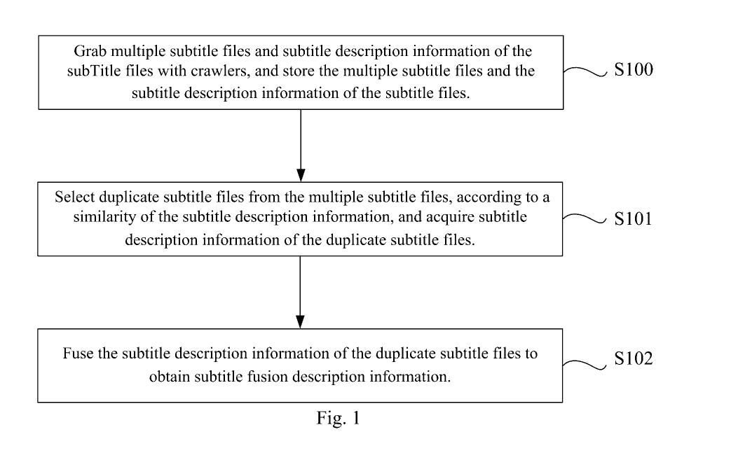

FIG. 1 shows a schematic flowchart of a method for subtitle data fusion according to an embodiment of the disclosure. As shown in FIG. 1, the method includes the following steps S100 to S102.

In step S100, multiple subtitle files and subtitle description information of the subtitle files are grabbed with crawlers and the multiple subtitle files and the subtitle description information of the subtitle files are stored.

For example, many subtitle websites such as Shooter.com and Renren.com may freely provide subtitle files and subtitle description information of the subtitle files for users. In step S100, multiple subtitle files and subtitle description information of the subtitle files are grabbed from various major subtitle websites with crawlers, and the multiple subtitle files and the subtitle description information of the subtitle files are stored, so that the subtitle description information is fused later.

The subtitle description information is used for describing relevant information of the subtitle files, and the subtitle description information includes title information, release time information, director information, cast information and subtitle language information. As titles of some TV drama in different countries are not exactly the same, the title information may include: the original title information, Chinese title information, English title information, title information in Hong Kong and title information in Taiwan.

In step S101, repetitive subtitle files are selected from the multiple subtitle files according to a similarity of the subtitle description information, and subtitle description information of the repetitive subtitle files is acquired.

For example, subtitle files with a high similarity, i.e., repetitive subtitle files are selected from the multiple subtitle files according to the similarity of the subtitle description information, and subtitle description information of the repetitive subtitle files is acquired.

In step S102, the subtitle description information of the repetitive subtitle files is fused to obtain subtitle fusion description information.

After the repetitive subtitle files are selected in step S101, the subtitle description information of the repetitive subtitle files is fused to obtain the subtitle fusion description information in step S102. Compared with the subtitle description information of the subtitle files, the subtitle fusion description information is more comprehensive and complete, which is convenient for the user to get comprehensive subtitle description information.

With the method for subtitle data fusion according to the embodiment of the disclosure, multiple subtitle files and subtitle description information of the subtitle files are grabbed with crawlers, repetitive subtitle files are selected from the multiple subtitle files according to the similarity of the subtitle description information, subtitle description information of the repetitive subtitle files is acquired, and then the subtitle description information of the repetitive subtitle files is fused to obtain subtitle fusion description information. Based on the technical solutions according to the disclosure, more comprehensive and complete subtitle fusion description information is obtained, thereby being convenient for the user to get the comprehensive and complete subtitle description information and improving the user experience.

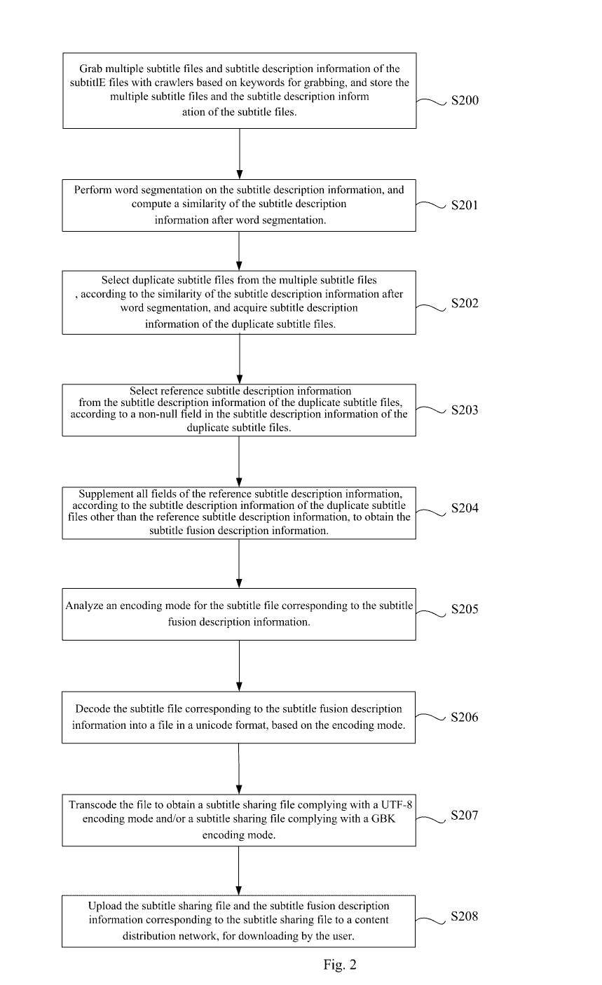

FIG. 2 shows a schematic flowchart of a method for subtitle data fusion according to an embodiment of the present disclosure. As shown in FIG. 2, the method includes the following steps S200 to S208.

In step S200, multiple subtitle files and subtitle description information of the subtitle files are grabbed with crawlers based on keywords for grabbing, and the multiple subtitle files and the subtitle description information of the subtitle files are stored.

The multiple subtitle files and subtitle description information of the subtitle files are grabbed from various major subtitle websites with crawlers based on keywords for grabbing, and the multiple subtitle files and the subtitle description information of the subtitle files are stored, so that the subtitle description information is fused later. Specifically, the multiple subtitle files and the subtitle description information of the subtitle files are managed through a management list.

The subtitle description information is used for describing relevant information of the subtitle files, and the subtitle description information includes title information, release time information, director information, cast information and subtitle language information. As titles of some TV drama in different countries are not exactly the same, the title information may include: the original title information, Chinese title information, English title information, title information in Hong Kong and title information in Taiwan.

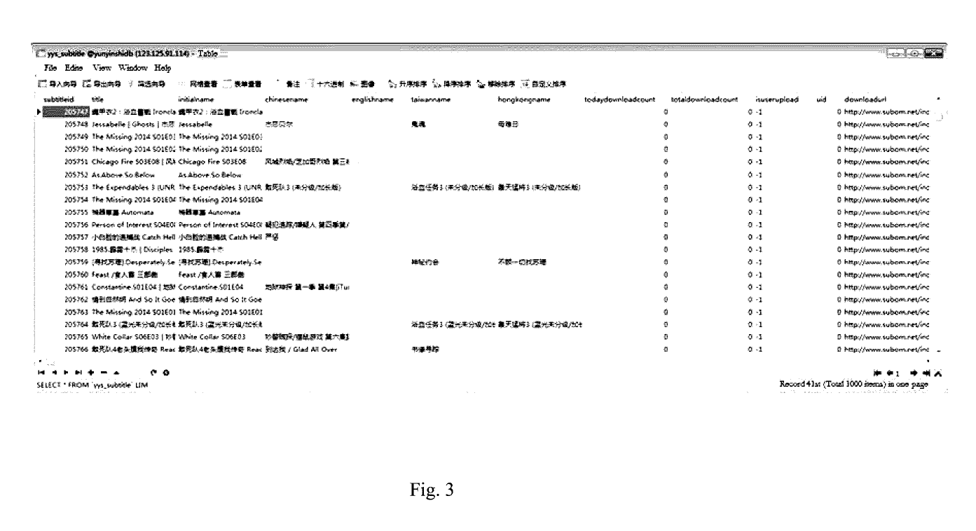

FIG. 3 is a schematic diagram of a management list. As shown in FIG. 3, subtitle description information of the multiple subtitle files is listed in the management list. Initial name information refers to the original title information, Chinese name information refers to Chinese title information, English name information refers to English title information, hongkong name information refers to title information in Hong Kong, and Taiwan name information refers to title information in Taiwan. As can be seen from FIG. 3, subtitle description information of some subtitle files is not comprehensive and has a null field. Taking subtitle description information of the second subtitle file listed in FIG. 3 as an example, the original title information of the subtitle file is “Jessabelle”, Chinese title information is “Jiesabeier( [symbol] )”, English title information is a null field, title information in Taiwan is “ghost( [symbol] )”, title information in Hong Kong is “mother hard day( [symbol] )”.

In step S201, word segmentation is performed on the subtitle description information, and a similarity of the subtitle description information after word segmentation is computed.

For example, word segmentation may be performed on the title information and the cast information in the subtitle description information, and the similarity of the subtitle description information after word segmentation is computed.

In step S202, repetitive subtitle files are selected from the multiple subtitle files according to the similarity of the subtitle description information after word segmentation, and subtitle description information of the repetitive subtitle files is acquired.

After the similarity is computed in step S201, subtitle files with a high similarity, i.e., repetitive subtitle files are selected from the multiple subtitle files according to the similarity of the subtitle description information after word segmentation, and subtitle description information of the repetitive subtitle files is acquired in step S202. For example, subtitle files with a similarity more than 80% may be selected from the multiple subtitle files, and may be used as repetitive subtitle files. Those skilled in the art may select subtitle files with a similarity in other range as repetitive subtitle files according to the practical needs.

In step S203, reference subtitle description information is selected from the subtitle description information of the repetitive subtitle files, according to a non-null field in the subtitle description information of the repetitive subtitle files.

After repetitive subtitle files are selected from the multiple subtitle files in step S202, reference subtitle description information is selected from the subtitle description information of the repetitive subtitle files, according to a non-null field in the subtitle description information of the repetitive subtitle files in step S203. For example, the repetitive subtitle files selected from the multiple subtitle files in step S202 include a subtitle file 1, a subtitle file 2 and a subtitle file 3. Subtitle description information of the subtitle file 1 includes 6 non-null fields, subtitle description information of the subtitle file 2 includes 5 non-null fields, and subtitle description information of the subtitle file 3 includes 7 non-null fields. In step S203, the subtitle description information including the most non-null fields may be selected from the subtitle description information of the subtitle file 1, the subtitle description information of the subtitle file 2 and the subtitle description information of the subtitle file 3, that is, the subtitle description information of the subtitle file 3 is used as the reference subtitle description information.

In step S204, all fields of the reference subtitle description information are supplemented according to the subtitle description information of the repetitive subtitle files other than the reference subtitle description information, to obtain the subtitle fusion description information.

For example, the repetitive subtitle files includes a subtitle file 1, a subtitle file 2 and a subtitle file 3, and the reference subtitle description information selected in step S203 is the subtitle description information of the subtitle file 3. In step S204, all fields of the subtitle description information of the subtitle file 3 are supplemented according to the subtitle description information of the subtitle file 1 and the subtitle description information of the subtitle file 2, to obtain more comprehensive and complete subtitle description information, thereby being convenient for the user to get the comprehensive subtitle description information.

Although the subtitle fusion description information is obtained by supplementing all fields of the subtitle description information of the subtitle file 3 in step S204, an encoding mode for the subtitle file 3 corresponding to the subtitle fusion description information might not always be an encoding mode for subtitle files supported by the existing video player. In order to facilitate the user using the subtitle files, the subtitle file corresponding to the subtitle fusion description information is further to be transcoded, to obtain a subtitle sharing file complying with at least one preset encoding mode, which may be implemented by following steps S205 to 5207.

In step S205, an encoding mode for the subtitle file corresponding to the subtitle fusion description information is analyzed.

In step S206, the subtitle file corresponding to the subtitle fusion description information is decoded into a file in a unicode format, based on the encoding mode.

In step S207, the file is transcoded to obtain a subtitle sharing file complying with a UTF-8 encoding mode and/or a subtitle sharing file complying with a GBK encoding mode.

In order to transcode the subtitle file corresponding to the subtitle fusion description information, the encoding mode for the subtitle file must be analyzed in step S205. After the encoding mode is analyzed, the subtitle file corresponding to the subtitle fusion description information is decoded into the file in the unicode format based on the encoding mode in step S206. Then the file is transcoded to obtain the subtitle sharing file complying with the UTF-8 encoding mode and/or the subtitle sharing file complying with the GBK encoding mode in step S207. Both the UTF-8 encoding mode and the GBK encoding mode are common encoding modes, and most of the video players with a subtitle playing function can support the subtitle sharing file complying with the UTF-8 encoding mode and the subtitle sharing file complying with the GBK encoding mode.

In step S207, the file in the unicode format is transcoded into the subtitle sharing file complying with the UTF-8 encoding mode and/or the subtitle sharing file complying with the GBK encoding mode, not only being easy to use of user, but also avoiding subtitle messy codes during use, and further improving the user experience.

In order to facilitate the user acquiring the subtitle sharing file and the subtitle fusion description information corresponding to the subtitle sharing file, the method for subtitle data fusion may further include a step of uploading the subtitle sharing file and the subtitle fusion description information corresponding to the subtitle sharing file to a content distribution network.

In step S208, the subtitle sharing file and the subtitle fusion description information corresponding to the subtitle sharing file are uploaded to the content distribution network, for downloading by the user.

With the method for subtitle data fusion according to the embodiment of the disclosure, multiple subtitle files and subtitle description information of the subtitle files are grabbed with crawlers, repetitive subtitle files are selected from the multiple subtitle files according to the similarity of the subtitle description information after word segmentation, subtitle description information of the repetitive subtitle files is acquired, then reference subtitle description information is selected from the subtitle description information of the repetitive subtitle files according to a non-null field in the subtitle description information of the repetitive subtitle files, all fields of the reference subtitle description information are supplemented to obtain the subtitle fusion description information, and the subtitle file corresponding to the subtitle fusion description information is transcoded to obtain the subtitle sharing file complying with the UTF-8 encoding mode and/or the subtitle sharing file complying with the GBK encoding mode, finally, the subtitle sharing file and the subtitle fusion description information corresponding to the subtitle sharing file are uploaded to the content distribution network, for download by the user. Based on the technical solutions according to the disclosure, not only more comprehensive and complete subtitle description information is obtained, but also the subtitle sharing files complying with the UTF-8 encoding mode and/or the subtitle sharing files complying with the GBK encoding mode are obtained, thereby being convenient for the user to get the comprehensive and complete subtitle description information, avoiding subtitle messy codes during the use of the subtitle sharing file, and improving the user experience. In addition, multiple repetitive subtitle files exist on the existing subtitle websites, which is inconvenient for the user to quickly get the required subtitle files. In the technical solutions according to the disclosure, the subtitle sharing file is uploaded to the content distribution network, thus the user can quickly find the required subtitle sharing file from the content distribution network, thereby saving search time for user.

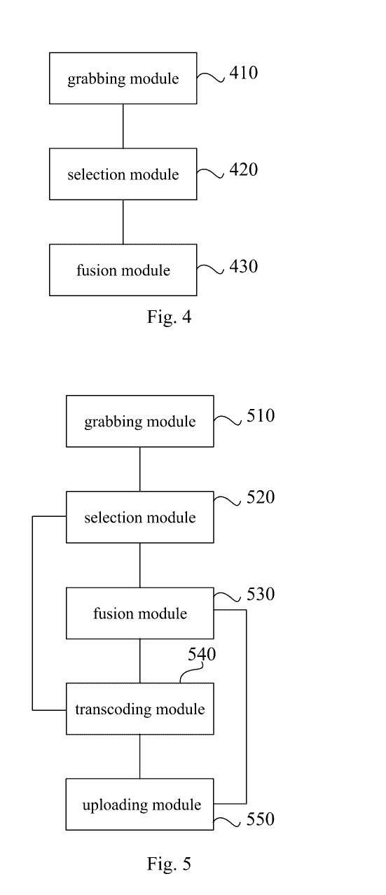

FIG. 4 shows a schematic structural diagram of an apparatus for subtitle data fusion according to an embodiment of the present disclosure. As shown in FIG. 4, the apparatus for subtitle data fusion includes: a grabbing module 410, a selection module 420, and a fusion module 430.

The grabbing module 410 is configured to grab multiple subtitle files and subtitle description information of the subtitle files with crawlers, and store the multiple subtitle files and the subtitle description information of the subtitle files.

Multiple subtitle files and subtitle description information of the subtitle files are grabbed by the grabbing module 410 from various major subtitle websites with crawlers, and the multiple subtitle files and the subtitle description information of the subtitle files are stored by the grabbing module 410, so that the subtitle description information is fused later. The subtitle description information is used for describing relevant information of the subtitle files, and the subtitle description information includes title information, release time information, director information, cast information and subtitle language information. Specifically, the title information may include: the original title information, Chinese title information, English title information, title information in Hong Kong and title information in Taiwan.

The selection module 420 is configured to select repetitive subtitle files from the multiple subtitle files, according to a similarity of the subtitle description information, and acquire subtitle description information of the repetitive subtitle files.

For example, subtitle files with a high similarity, i.e., repetitive subtitle files are selected by the selection module 420 from the multiple subtitle files according to the similarity of the subtitle description information, and subtitle description information of the repetitive subtitle files is acquired by the selection module 420.

The fusion module 430 is configured to fuse the subtitle description information of the repetitive subtitle files to obtain subtitle fusion description information.

After the repetitive subtitle files are selected by the selection module 420, the subtitle description information of the repetitive subtitle files is fused by the fusion module 430 to obtain the subtitle fusion description information. Compared with the subtitle description information of the subtitle files, the subtitle fusion description information is more comprehensive and complete, which is convenient for the user to get comprehensive subtitle description information.

With the apparatus for subtitle data fusion according to the embodiment of the disclosure, multiple subtitle files and subtitle description information of the subtitle files are grabbed by the grabbing module, repetitive subtitle files are selected by the selection module from the multiple subtitle files according to the similarity of the subtitle description information, subtitle description information of the repetitive subtitle files is acquired by the selection module, and then the subtitle description information of the repetitive subtitle files is fused by the fusion module to obtain subtitle fusion description information. Based on the technical solutions according to the disclosure, more comprehensive and complete subtitle description fusion information is obtained, thereby being convenient for the user to get the comprehensive and complete subtitle description information and improving the user experience.

FIG. 5 shows a schematic structural diagram of an apparatus for subtitle data fusion according to an embodiment of the present disclosure. As shown in FIG. 5, the apparatus for subtitle data fusion includes: a grabbing module 510, a selection module 520, a fusion module 530, a transcoding module 540 and an uploading module 550.

The grabbing module 510 is configured to grab multiple subtitle files and subtitle description information of the subtitle files with crawlers based on keywords for grabbing, and store the multiple subtitle files and the subtitle description information of the subtitle files.

Multiple subtitle files and subtitle description information of the subtitle files are grabbed by the grabbing module 510 from various major subtitle websites with crawlers based on keywords for grabbing, and the multiple subtitle files and the subtitle description information of the subtitle files are stored by the grabbing module 510, so that the subtitle description information is fused later. The subtitle description information is used for describing relevant information of the subtitle files, and the subtitle description information includes title information, release time information, director information, cast information and subtitle language information. Specifically, the title information may include: the original title information, Chinese title information, English title information, title information in Hong Kong and title information in Taiwan.

The selection module 520 is configured to perform word segmentation on the subtitle description information, and compute a similarity of the subtitle description information after word segmentation, and select repetitive subtitle files from the multiple subtitle files, according to the similarity of the subtitle description information after word segmentation, and acquire subtitle description information of the repetitive subtitle files.

For example, word segmentation may be performed by the selection module 520 on the title information and the cast information in the subtitle description information, and the similarity of the subtitle description information after word segmentation is computed. After the similarity is computed, subtitle files with a high similarity, i.e., repetitive subtitle files are selected by the selection module 520 from the multiple subtitle files according to the similarity of the subtitle description information after word segmentation, and subtitle description information of the repetitive subtitle files is acquired by the selection module 520. For example, subtitle files with a similarity more than 80% may be selected from the multiple subtitle files, and may be used as repetitive subtitle files. Those skilled in the art may select subtitle files with a similarity in other range as repetitive subtitle files in accordance with the practical needs.

The fusion module 530 is configured to select reference subtitle description information from the subtitle description information of the repetitive subtitle files, according to a non-null field in the subtitle description information of the repetitive subtitle files, and supplement all fields of the reference subtitle description information, according to the subtitle description information of the repetitive subtitle files other than the reference subtitle description information, to obtain the subtitle fusion description information.

After repetitive subtitle files are selected by the selection module 520 from the multiple subtitle files, reference subtitle description information is selected by the fusion module 530 from the subtitle description information of the repetitive subtitle files, according to a non-null field in the subtitle description information of the repetitive subtitle files. For example, the repetitive subtitle files selected by the selection module 520 from the multiple subtitle file include a subtitle file 1, a subtitle file 2 and a subtitle file 3. Subtitle description information of the subtitle file 1 includes 6 non-null fields, subtitle description information of the subtitle file 2 includes 5 non-null fields, and subtitle description information of the subtitle file 3 includes 7 non-null fields. The subtitle description information including the most non-null fields may be selected by the fusion module 530 from the subtitle description information of the subtitle file 1, the subtitle description information of the subtitle file 2 and the subtitle description information of the subtitle file 3, that is, the subtitle description information of the subtitle file 3 is used as the reference subtitle description information. All fields of the subtitle description information of the subtitle file 3 are supplemented according to the subtitle description information of the subtitle file 1 and the subtitle description information of the subtitle file 2, to obtain more comprehensive and complete subtitle description information, thereby being convenient for the user to get the comprehensive subtitle description information.

The transcoding module 540 is configured to transcode the subtitle files corresponding to the subtitle fusion description information, to obtain subtitle sharing files complying with at least one preset encoding mode.

The transcoding module 540 is further configured to analyze an encoding mode for the subtitle file corresponding to the subtitle fusion description information; decode the subtitle file corresponding to the subtitle fusion description information into a file in a unicode format, based on the encoding mode; and transcode the file to obtain a subtitle sharing file complying with a UTF-8 encoding mode and/or a subtitle sharing file complying with a GBK encoding mode.

Although the subtitle fusion description information is obtained by the fusion module 530 supplementing all fields of the subtitle description information of the subtitle file 3, an encoding mode for the subtitle file 3 corresponding to the subtitle fusion description information might not always be an encoding mode for subtitle files supported by the existing video player. In order to facilitate the user using the subtitle files, the subtitle file corresponding to the subtitle fusion description information is further to be transcoded by the transcoding module 540, to obtain a subtitle sharing file complying with a UTF-8 encoding mode and/or a subtitle sharing file complying with a GBK encoding mode.

In order to facilitate the user acquiring the subtitle sharing file, the apparatus for subtitle data fusion may further include the uploading module 550 configured to upload the subtitle sharing file and the subtitle fusion description information corresponding to the subtitle sharing file to a content distribution network, for downloading by the user.

With the apparatus for subtitle data fusion according to the embodiment of the disclosure, multiple subtitle files and subtitle description information of the subtitle files are grabbed by the grabbing module, repetitive subtitle files are selected by the selection module from the multiple subtitle files according to the similarity of the subtitle description information after word segmentation, subtitle description information of the repetitive subtitle files is acquired by the selection module, then reference subtitle description information is selected by the fusion module from the subtitle description information of the repetitive subtitle files, all fields of the reference subtitle description information are supplemented by the fusion module to obtain the subtitle fusion description information, and the subtitle file corresponding to the subtitle fusion description information is transcoded by the transcoding module to obtain the subtitle sharing file complying with the UTF-8 encoding mode and/or the subtitle sharing file complying with the GBK encoding mode, finally, the subtitle sharing file and the subtitle fusion description information corresponding to the subtitle sharing file are uploaded by the uploading module to the content distribution network, for downloading by the user. Based on the technical solutions according to the disclosure, not only more comprehensive and complete subtitle description information is obtained, but also the subtitle sharing file complying with at least one preset encoding mode are obtained, thereby being convenient for the user to quickly and easily get the comprehensive and complete subtitle fusion description information and the subtitle sharing file corresponding to the subtitle fusion description information from the content distribution network, avoiding subtitle messy codes during the use of the subtitle sharing file, and improving the user experience.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the present disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the devices for displaying the website authentication information according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

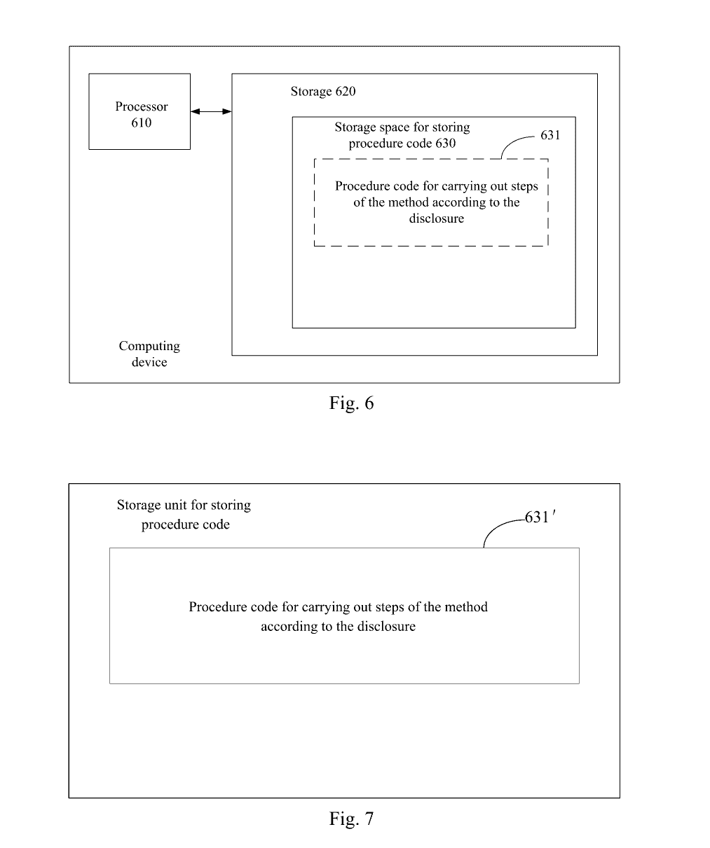

For example, FIG. 6 shows a diagram for a computing device for executing the method for subtitle data fusion according to the disclosure. The computing device traditionally comprises a processor 610 and a computer program product in the form of storage 620 or a computer readable medium. The storage 620 can be electronic storage such as flash memory, EEPROM (Electrically Erasable Programmable Read-Only Memory), EPROM, hard disk or ROM, and the like. Storage 620 possesses storage space 630 for storing procedure code 631 for carrying out any steps of aforesaid method. For example, storage space 630 for storing procedure code can comprise various procedure codes 631 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 6. The storage cell can possess memory paragraph, storage space like the storage 620 in the computing device in FIG. 7. The procedure code can be compressed in, for example, a proper form. Generally, storage cell comprises computer readable code 631′, i.e. the code can be read by processors such as 610 and the like. When the codes run on a computer device, the computer device will carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the devices can be embodied by a same hardware item. The use of words first, second and third does not mean any sequence. These words can be explained as name.

1. A method for subtitle data fusion, comprising:
grabbing, with crawlers, a plurality of subtitle files and subtitle description information of the subtitle files, and storing the plurality of subtitle files and the subtitle description information of the subtitle files;
selecting repetitive subtitle files from the plurality of subtitle files, according to a similarity of the subtitle description information, and acquiring subtitle description information of the repetitive subtitle files; and
fusing the subtitle description information of the repetitive subtitle files to obtain subtitle fusion description information.

2. The method according to claim 1, wherein the grabbing a plurality of subtitle files and subtitle description information of the subtitle files with crawlers comprises: grabbing, with crawlers, a plurality of subtitle files and subtitle description information of the subtitle files, based on keywords for grabbing.

3. The method according to claim 1, wherein the acquiring subtitle description information of the repetitive subtitle files comprises:
performing word segmentation on the subtitle description information, and computing a similarity of the subtitle description information after the word segmentation; and
selecting repetitive subtitle files from the plurality of subtitle files, according to the similarity of the subtitle description information after word segmentation, and acquiring subtitle description information of the repetitive subtitle files.

4. The method according to claim 1, wherein the fusing the subtitle description information of the repetitive subtitle files to obtain subtitle fusion description information comprises:
selecting reference subtitle description information from the subtitle description information of the repetitive subtitle files, according to a non-null field in the subtitle description information of the repetitive subtitle files; and
supplementing fields of the reference subtitle description information, according to the subtitle description information of the repetitive subtitle files other than the reference subtitle description information, to obtain the subtitle fusion description information.

5. The method according to claim 1, wherein the method further comprises: transcoding the subtitle files corresponding to the subtitle fusion description information, to obtain subtitle sharing files complying with at least one preset encoding mode.

6. An electronic device, comprising:
at least one processor; and
a memory communicably connected with the at least one processor for storing instructions executable by the at least one processor, wherein execution of the instructions by the at least one processor causes the at least one processor to:
grab a plurality of subtitle files and subtitle description information of the subtitle files with crawlers, and store the plurality of subtitle files and the subtitle description information of the subtitle files;
select repetitive subtitle files from the plurality of subtitle files, according to a similarity of the subtitle description information, and acquire subtitle description information of the repetitive subtitle files; and
fuse the subtitle description information of the repetitive subtitle files to obtain subtitle fusion description information.

7. The electronic device according to claim 6, wherein the step to grab a plurality of subtitle files and subtitle description information of the subtitle filed with crawlers comprises: grabbing a plurality of subtitle files and subtitle description information of the subtitle files with crawlers, based on keywords for grabbing.

8. The electronic device according to claim 6, wherein the step to acquire subtitle description information of the repetitive subtitle files comprise:
performing word segmentation on the subtitle description information, and compute a similarity of the subtitle description information after word segmentation; and
selecting repetitive subtitle files from the plurality of subtitle files, according to the similarity of the subtitle description information after word segmentation, and acquire subtitle description information of the repetitive subtitle files.

9. The electronic device according to claim 6, wherein the step to fuse the subtitle description information of the repetitive subtitles files to obtain subtitle fusion descriptions information comprises:
selecting reference subtitle description information from the subtitle description information of the repetitive subtitle files, according to a non-null field in the subtitle description information of the repetitive subtitle files; and
supplementing all fields of the reference subtitle description information, according to the subtitle description information of the repetitive subtitle files other than the reference subtitle description information, to obtain the subtitle fusion description information.

10. The electronic device according to claim 6, wherein the execution of the instructions by the at least one processor further causes the at least one processor to transcode the subtitle files corresponding to the subtitle fusion description information, to obtain subtitle sharing files complying with at least one preset encoding mode.

11. A non-transitory computer-readable storage medium storing executable instructions that, when executed by an electronic device, causes the electronic device to:
grab a plurality of subtitle files and subtitle description information of the subtitle files with crawlers, and store the plurality of subtitle files and the subtitle description information of the subtitle files;
select repetitive subtitle files from the plurality of subtitle files, according to a similarity of the subtitle description information, and acquire subtitle description information of the repetitive subtitle files; and
fuse the subtitle description information of the repetitive subtitle files to obtain subtitle fusion description information.

12. The non-transitory computer-readable storage medium according to claim 11, wherein the step to grab a plurality of subtitle files and subtitle description information of the subtitle files with crawlers comprises: grabbing a plurality of subtitle files and subtitle description information of the subtitle files with crawlers, based on keywords for grabbing.

13. The non-transitory computer-readable storage medium according to claim 11, wherein the step to acquire subtitle description information of the repetitive subtitle files comprises:
performing word segmentation on the subtitle description information, and compute a similarity of the subtitle description information after word segmentation; and
selecting repetitive subtitle files from the plurality of subtitle files, according to the similarity of the subtitle description information after word segmentation, and acquire subtitle description information of the repetitive subtitle files.

14. The non-transitory computer-readable storage medium according to claim 11, wherein the step to fuse the subtitle description information of the repetitive subtitle files to obtain subtitle fusion description information comprises:
selecting reference subtitle description information from the subtitle description information of the repetitive subtitle files, according to a non-null field in the subtitle description information of the repetitive subtitle files; and
supplementing all fields of the reference subtitle description information, according to the subtitle description information of the repetitive subtitle files other than the reference subtitle description information, to obtain the subtitle fusion description information.

15. The non-transitory computer-readable storage medium according to claim 11, wherein the execution of the instructions by the at least one processor further causes the at least one processor to: transcode the subtitle files corresponding to the subtitle fusion description information, to obtain subtitle sharing files complying with at least one preset encoding mode.
